(19) United States
(12) Patent Application Publication
(10) Pub. No.: US 2015/0100830 A1
(43) Pub. Date: Apr. 9, 2015

(54) METHOD AND SYSTEM FOR SELECTING AND EXECUTING TEST SCRIPTS

(71) Applicants: Manjunatha Nanjundappa, Bangalore (IN); Prabhu S., Bangalore (IN); Sunil Mallaraju Gugri, Bangalore (IN)

(72) Inventors: Manjunatha Nanjundappa, Bangalore (IN); Prabhu S., Bangalore (IN); Sunil Mallaraju Gugri, Bangalore (IN)

(73) Assignee: Unisys Corporation, Blue Bell, PA (US)

(21) Appl. No.: 14/094,855

(22) Filed: Dec. 3, 2013

(30) Foreign Application Priority Data
Oct. 4, 2013 (IN) 2948/DEL/2013

(51) Int. Cl. G06F 11/36

(52) U.S. Cl. CPC G06F 11/3688
USPC 714/38.1

(57) ABSTRACT

Systems and methods are disclosed herein to a method for reusing test automation framework across multiple applications, the method comprises receiving a selection of one or more test scripts from a user to test an application; creating an execution list containing every selected test script; loading the instructions of the test script into the computer-readable memory when the test script is found in the test script repository; executing the test script testing the application according to the instructions defined in the test script and according to computer instructions defined by the utility functions or the common functions when the test script calls either the common functions or the utility functions; checking the application's status after the test terminates operation; and recovering and closing the application if the application failed before executing a second test script testing the application.

### TECHNICAL FIELD

The present invention relates generally to automated testing software, and more particularly, to systems and methods for executing automated testing software in an efficient manner.

### BACKGROUND

Software testing is an integral process in the development of any software application. Most software undergoes rigorous testing in search of software bugs, glitches, and issues within the software application. Software testing also seeks to find features and functions of the software application that are not performing according to specification after the application builds.

To efficiently perform software testing, many organizations perform testing using test automation techniques. Test automation is the use of special software, which is separate from the software being tested, to control the execution of tests and the comparison of actual results to predicted outcomes. Most automation projects begin with a feasibility study to evaluate particular benefits of existing automation tools. Most of the conventional automation tools are designed to automate tests with specific applications or products built with specific technology. However, there is no universal tool that can perform test automation for all software applications and products. For example, HP Winrunner does not support .NET applications. As another example, a user interface-specific test automation framework may not be a good candidate for testing console-based applications.

While conventional tools may work for some software applications, in many cases organizations may need to create their own test automation frameworks. Creating test automation frameworks requires a great deal of time and money, which must be evaluated before beginning the process of creating testing software. As a result of the limitations of conventional test automation applications and the costs involved in creating new test automation software, there exists a need to reuse aspects of test automation frameworks across multiple software applications.

If an organization decides to create a unique test automation framework, the process of performing all of the tests executed by the automation framework still requires a long period of time. The time to test all the features and functions of the software application under test may be in the order of days or weeks depending on the size and complexity of the software application under test. Generally, the more complex a software application, the more tests that need to be created and executed. Often the number of tests performed by the automation framework is in the thousands, tens of thousands, or more. Also, once a cycle of tests is performed, errors in the software under tests are often discovered, which requires a software engineer to fix the problem, and then run the test cycle again until the software is error free. Such a debugging process may take weeks or months depending on the resources available and the complexity of the application under test.

The amount of time necessary to test a software application increases if the software application is expected to run on multiple platforms. For example, if the software application is expected to run on Windows XP, Windows 7, Window 2003, and Windows 2008 R2, each test cycle must be performed on each platform. In essence, multiple platforms multiplies the amount of time allocated to testing,

In light of all these problems, there exists a need to decrease the amount of time for loading test software, running the test automation software, and testing software on multiple platforms.

### SUMMARY

The systems and methods described herein attempt to overcome the drawbacks discussed above by creating a reusable test automation framework that can be reused for multiple applications. Because designing and building test automation framework generally requires the majority of the time and work necessary to build the test automation framework, the reusable framework described in the exemplary embodiments can perform rigorous software testing without the increased overhead of designing an application-specific framework.

Also, the systems and methods described herein attempt to overcome the drawbacks discussed above by performing testing in a cyclical manner so that subsets of the set of tests may be run in parallel to divide the amount of time required to perform the testing. After fixing the problems found in testing, the subsets are rotated to different platforms so that no platform runs the same tests in two consecutive rounds of testing.

Also, the systems and methods described herein attempt to overcome the drawbacks discussed above by performing a random selection method to decreases testing time because multiple tests may be run simultaneously on different platforms. Also, through the random testing method, loading time for test scripts is reduced because only one test script is being loaded at a time, rather than an entire execution list containing all test scripts.

Further, the systems and methods described herein attempt to overcome the drawbacks discussed above by providing a convenient and mobile platform to track test execution status. The smartphone application also allows a software engineer monitoring the testing process to monitor the status while away from the computer system performing the testing process. Software engineers also can respond immediately to errors without routinely checking the status of the test at the server's location,

In one embodiment, a method for reusing a test automation framework across multiple applications, the method comprises receiving, by a computer, a selection of one or more test scripts from a user to test an application; creating, by the computer, an execution list containing every selected test script; copying, by the computer, at least one utility function and at least one common function into a computer-readable memory so that the at least one utility function and at least one common function are available to be referenced by an executed test script, wherein the utility function defines a function used by the test automation framework and the common function defines a function that is test script-specific; referencing, by the computer, a test script repository for one of the one or more test scripts having a test name that matches a name in the execution list; loading, by the computer, the instructions of the test script into the computer-readable memory when the test script is found in the test script repository; executing, by the computer, the test script to test the application according to the instructions defined in the test script and according to computer instructions defined by the utility functions or the common functions when the test script calls either the common function or the utility function; checking, by the computer, a status of the application after the test terminates operation; and recovering and closing, by the computer, the application if the application failed before executing a second test script testing the application under test.

In another embodiment, a computer program product, comprising a computer usable medium having a computer readable program code embodied therein, the computer readable program code adapted to be executed to implement a method for testing an application, the method comprises providing a first system, wherein the first system comprises distinct software modules, and wherein the distinct software modules comprises an application setup initializer module, an application status checker module, a test script selector module, and a driver module; receiving, by the test scripts selector module, a selection of one or more test scripts from a user to test the application; creating, by the driver module, an execution list containing every selected test script; copying, by the driver module, utility functions and common functions into computer-readable memory so that the utility functions and common functions are available to be referenced by an executed test script, wherein the utility functions define functions used by a test automation framework and the common functions define functions that are test script-specific; referencing, by the driver module, a test script repository for one of the one or more test scripts having a test name that matches a name in the execution list; loading, by the driver module, the instructions of the test script into the computer-readable memory when the test script is found in the test script repository; executing, by the driver module, the test script testing the application according to the instructions defined in the test script and according to computer instructions defined by the utility functions or the common functions when the test script calls either the common functions or the utility functions; checking, by the application status checker module, the status of the application after the test terminates operation; and recovering and closing, by the application initializer module, the application if the application failed before executing a second test script testing the application.

In yet another embodiment, a method for cyclically performing tests on multiple platforms, the method comprises identifying, by a computer, a number of platforms on which to test an application; receiving, by the computer, a selection from a user of one or more tests used to test features or functions of the application; allocating, by the computer, the one or more tests into a number of sets, wherein the number of sets is equal to the number of platforms on which to test the application; distributing, by the computer, one set of tests to each platform so that each platform executes a received set of tests during a first round of testing; capturing, by the computer, results of the sets of tests from each platform after a test terminates; receiving, by the computer, an updated build of the application after addressing an issue with the application found as a result of the first round of testing; and distributing, by the computer, one set of tests to each platform so that each platform executes a received set of tests during a second round of testing, wherein the each platform receives a different set of tests during the second round of testing than the set of tests received in the first round of testing.

In still yet another embodiment, a computer program product, comprising a computer usable medium having a computer readable program code embodied therein, the computer readable program code adapted to be executed to implement a method for cyclically performing tests on multiple platforms comprises providing a first system, wherein the first system comprises distinct software modules, and wherein the distinct software modules comprises a test selection module, a test execution module, a test allocation module, and a test results gathering module; identifying, by the test allocation module, a number of platforms on which to test an application; receiving, by the test selection module, a selection from a user of one or more tests used to test features or functions of the application; allocating, by the test allocation module, the one or more tests into a number of sets, wherein the number of sets is equal to the number of platforms on which to test the application; distributing, by the test allocation module, one set of tests to each platform so that each platform executes one set of tests during a first round of testing; capturing, by the test results gathering module, results of the sets of tests from each platform after a test terminates; receiving, by the test execution module, an updated build of the application after addressing an issue with the application found as a result of the first round of testing; and distributing, by the test allocation module, one set of tests to each platform so that each platform executes one set of tests during a second round of testing, wherein the each platform receives a different set of tests during the second round of testing than the set of tests received in the first round of testing.

In another embodiment, a method for random test selection on multiple platforms comprises receiving, by a computer, one Or more selections from a user selecting tests to execute during a testing process; receiving, by the computer, one or more selections from a user selecting at least one client computer on which to execute the selected tests during a testing process; loading, by the computer, a testing application framework; randomly selecting, by the computer, a first test script from the one or more selected tests for a first selected client computer; sending, by the computer, a test name for the first randomly selected test script to the first selected client computer, wherein the first selected client computer receives the name of the first randomly selected test script through a client listener module installed on the first selected client computer; receiving, by the computer, results of the first randomly selected test executed by the first selected client computer, wherein the results are sent from the client listener module; and updating, by the computer, a results sheet with any failed tests when a failed test is reported by the client listener module of the first selected client computer.

In yet another embodiment, a computer program product, comprising a computer usable medium having a computer readable program code embodied therein, the computer readable program code adapted to be executed to implement a method for random test selection on multiple platforms comprises providing a first system, wherein the first system comprises distinct software modules, and wherein the distinct software modules comprises a master scheduler module, a test and client selector module, a controller module, and a random selector module; receiving, by the test and client selector module, one or more selections from a user selecting tests to execute during a testing process; receiving, by the test and client selector module, one or more selections from a user selecting client computers on which to execute the selected tests during a testing process; loading, by the master scheduler module, a testing application framework; randomly selecting, by the random selector module, a first test script from the one or more selected tests for a first selected client computer; sending, by the controller module, a test name for the first randomly selected test script to the first selected client computer, wherein the first selected client computer receives the name of the first randomly selected test script through a client listener module installed on the first selected client computer; receiving, by the controller module, results of the first randomly selected test executed by the first selected client computer, wherein the results are sent from the client listener module; and updating, by the controller, a results sheet with any failed tests when a failed test is reported by the client listener module of the first selected client computer.

In still yet another embodiment, a method for controlling a software testing process using a smartphone comprises executing, by a server, a test script testing an application using a test automation framework; storing, by the server, an error message in an input folder about an error when the framework determines that the error has occurred during testing; and sending, by the server via a wireless network, the error message to the smartphone when an agent determines that the error message has been placed into the input folder, wherein the agent continually monitors the input folder for error messages placed in the input folder by the framework, wherein the error message is configured to display an alert to the user on the smartphone.

In another embodiment, a computer program product, comprising a computer usable medium having a computer readable program code embodied therein, the computer readable program code adapted to be executed to implement a method for controlling a software testing process using a smartphone comprises providing a first system, wherein the first system comprises distinct software modules, and wherein the distinct software modules comprises a framework module, an agent module, and a smartphone application module; executing, the framework module, a test script testing an application under test; placing, by the framework module, an error message in an input folder about an error when the framework module determines that the error has occurred during testing; and sending, by the agent module, the error message to a smartphone application module of the smartphone when the agent module determines that the error message has been placed into the input folder, wherein the agent module continually monitors the input folder for error messages placed in the input folder by the framework module.

Additional features and advantages of an embodiment will be set forth in the description which follows, and in part will be apparent from the description. The objectives and other advantages of the invention will be realized and attained by the structure particularly pointed out in the exemplary embodiments in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

The accompanying drawings constitute a part of this specification and illustrate an embodiment of the invention and together with the specification, explain the invention.

FIG. 1 illustrates a framework diagram for a reusable test automation framework according to an exemplary embodiment.

FIG. 2 illustrates a flow diagram representing a method for using the reusable test automation framework according to an exemplary embodiment.

FIG. 3 illustrates a screen shot of the reusable test automation framework's graphical user interface according to an exemplary embodiment,

FIG. 4 illustrates a screen shot of results from tests performed using the reusable test automation framework displayed by the reusable test automation framework's graphical user interface according to an exemplary embodiment.

FIG. 5 illustrates a cyclical testing method performed on four distinct platforms according to an exemplary embodiment.

FIG. 6 illustrates a flow diagram for the cyclical testing method according to an exemplary embodiment,

FIG. 7 illustrates the modules and computer systems involved in a random test selection testing method according to an exemplary embodiment,

FIG. 8 illustrates a flow diagram for the random test selection testing method according to an exemplary embodiment.

FIG. 9 illustrates the modules and computer systems involved to control test automation software using a smartphone according to an exemplary embodiment.

FIG 10 illustrates a flow diagram for controlling test automation using a smartphone according to an exemplary embodiment.

### DETAILED DESCRIPTION

Reference will now be made in detail to the preferred embodiments, examples of which are illustrated in the accompanying drawings.

The embodiments described above are intended to be exemplary. One skilled in the art recognizes that numerous alternative components and embodiments may be substituted for the particular examples described herein and still fall within the scope of the invention.

Test automation frameworks comprise computer-readable commands, which may be in the form of a script. A test automation framework and an application under test may be processed by the same computer or by different computers. For example, a computer system may run the application under test and the test automation framework simultaneously during a testing process. The computer system may have multiple processors, which perform different tasks in parallel to run both the application under test and the test automation framework. In another case, a host computer running the test automation framework may connect to a client computer system running the application under test through a network connection. The host computer system may provide test-related instructions to the client computer system over the network at the direction of the test automation framework. In such a configuration, the application under test runs on a client computer system, and the test automation framework runs on a host computer. The test automation framework may connect to a plurality of client computers, each running a version of the application under test. All computers involved in the testing process include at least a processor, memory hardware, and a physical data storage device. But the configuration and specification of each computer may differ.

Test automation frameworks generally require a framework built specifically for the application under test it may be desirable to create an application independent framework that can be reused for multiple applications. Because designing and building test automation framework generally requires the majority of the time and work necessary to build the test automation framework, the reusable framework described in the exemplary embodiments can perform rigorous software testing without the increased overhead of designing an application-specific framework.

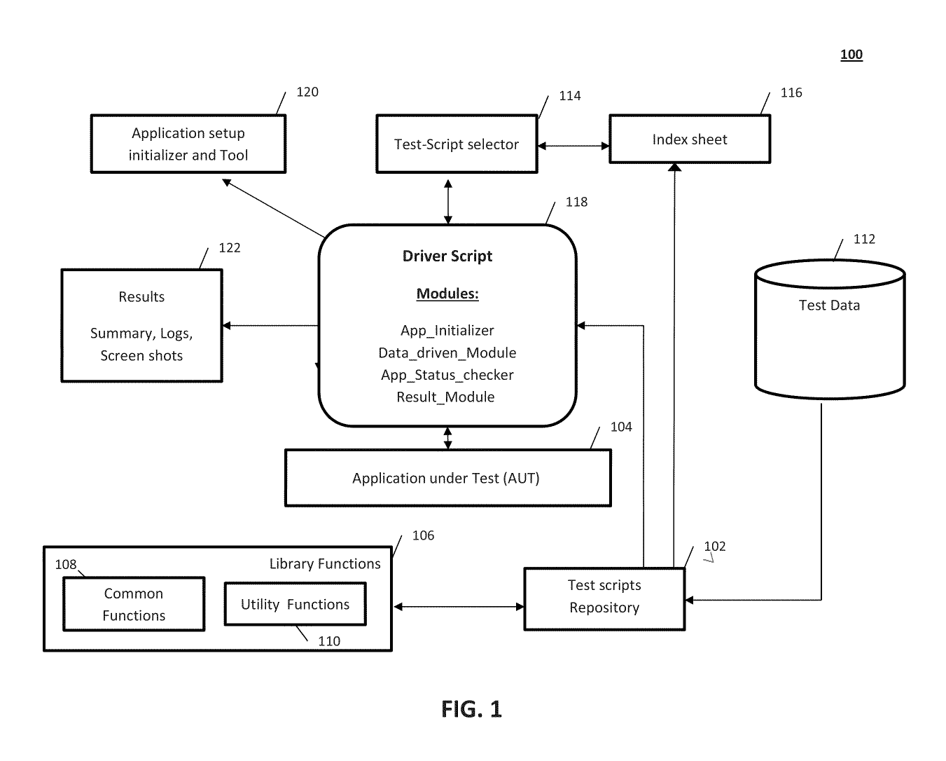

FIG. 1 illustrates a reusable framework for a reusable test automation framework according to an exemplary embodiment. The reusable test automation framework 100 includes a test scripts repository 102 that contains test scripts used by the test automation framework. The test scripts contained within the test scripts repository 102 are independent in execution. Each test script in the test script repository 102 tests a specific feature, variable, function, or any other aspect of an application under test (AUT) 104.

The test scripts repository 102 references library functions 106 when the test scripts are executed. The library functions 106 contain functions developed and placed for reusability. The library functions 106 are divided into two categories: common functions 108 and utility functions 110. The common functions 108 are used across the test scripts and are specific to a project. The utility functions 110 are used to aid the framework's execution. The test scripts repository 102 can reference the common functions 108 and the utility functions 110 comprising the library functions 106 before executing a test. The test scripts find the necessary variables, functions, and scripting calls for specific testing procedures in either the common functions 108 or the utility functions 111). As a result, a called test script may reference either or both of the common functions 108 and the utility functions 110 to gather the information, functions, and variables needed to perform the test.

For example, the functions in the library functions 106 may be written in a scripting language, such as AutoIt. The AutoIt scripting language may be useful for automating Windows GUI testing. The functions in the library functions 106 assist the test scripts in the test script repository 102 to perform testing on different applications without the reusable test automation framework 100 being application specific.

The test scripts within the test script repository 102 each have a name. The test name may be used to reference and find selected test scripts. Test names may be known across most or all of the modules and components that comprise the reusable test automation framework 100 so that other modules and components may call a test script and implement the test script on the AUT 104.

The test script repository 102 also receives test data from the test data storage 112. The test data storage 112 contains one test sheet or each test script, and the test data within the test data storage 112 includes a reference to a corresponding test script, which may be in the form of storing the test script name within the test data. The test data container 112 also includes sets of test data needed to perform each test. For example, the test data may include multiple sets of test data that must all be checked via, testing. Some test scripts may need to verify a proper result using multiple sets of input data, and that input data is stored in the test data storage 112. In addition, the test data storage 112 contains test sheets, and each test sheet contains a list of manual test cases with metadata, such as the test script name and the priority. Unless all sets of test data pass the testing criteria, the test script will fail.

The reusable test automation framework 100 allows a user to select test scripts from all or a subset of the test scripts contained in the test script repository 102. The user may select test scripts using the test script selector 114. The test script selector 114 references an index sheet 116 to gather and display all the available test scripts. The index sheet 116 is in communication with the test script repository 102 to gather the test names and any other pertinent data about the test scripts from the test script repository 102, so that the test script selector 114 may display a list of available test scripts to the user.

The reusable test automation framework 100 includes a driver script 118, which is the core of the framework 100. Once the user selects some or all of the test scripts in the test script repository 102, the test script selector 114 provides the selected test script names to driver script 118. Once provided with the selected test script names, the driver script 118 requests and receives test scripts from the test scripts repository 102. The test scripts repository 102 also provides test data from the test data storage 112 and the common functions 108 and utility functions 110 necessary to perform each test script. Once all of the test scripts and corresponding information has been provided to the driver script 118, the driver script 118 begins to execute the test scripts in any order, such as the order selected by the user or an order based on priority data.

The driver script 118 includes at least four functions: an application initializer (app_initializer), a data driven module (data driven module), an application status checker (app_status_checker), and a results consolidation module (results_module). The application initializer (app_initializer) loads the AUT 104 and a framework path used by the reusable test automation framework 100. The application initializer (app initializer) calls an application setup and initializer framework 120 to perform application setup and initialization. The data driven module (data_driven_module) checks whether the selected test scripts need to be executed with multiple sets of test data and triggers the reusable test automation framework 100 to handle the multiple sets of test data accordingly. The application status checker (app_status_checker) checks the status of the AUT 104 after each test script's execution or periodically throughout the process of executing a test script. The application status checker (app_status_checker) generates information about whether the NUT 104 stops, freezes, or runs properly during the test. Finally, the results consolidation module (results_module) consolidates and formats test result data 122 into an FITML format, or any other format, which is ultimately displayed to the user. The results consolidation module (results_module) may include summaries, logs, and snapshots with the HTML result data 122.

Using the modules described above, the driver script 118 executes test scripts in a synchronous and unattended way. The driver script 118 acts as an interface between the user and the computer system executing the driver script 118. It should be noted that a first computer system may execute the AUT 104 while a second computer system executes the modules and components of the reusable test automation framework 100, or a single computer may execute both the reusable test automation framework 100 and the AUT 104. In either embodiment, the computer system may at least include one or more processors configured to perform the processes defined by computer-readable instructions, memory for storing computer-readable instructions and other computer-readable data, and an input/output interface for displaying data to the user through a screen and receiving instructions and selections from the users, for example, through a keyboard, mouse, touch screen, or any other input device. The computer system may further include network communication hardware for communicating with other digital devices.

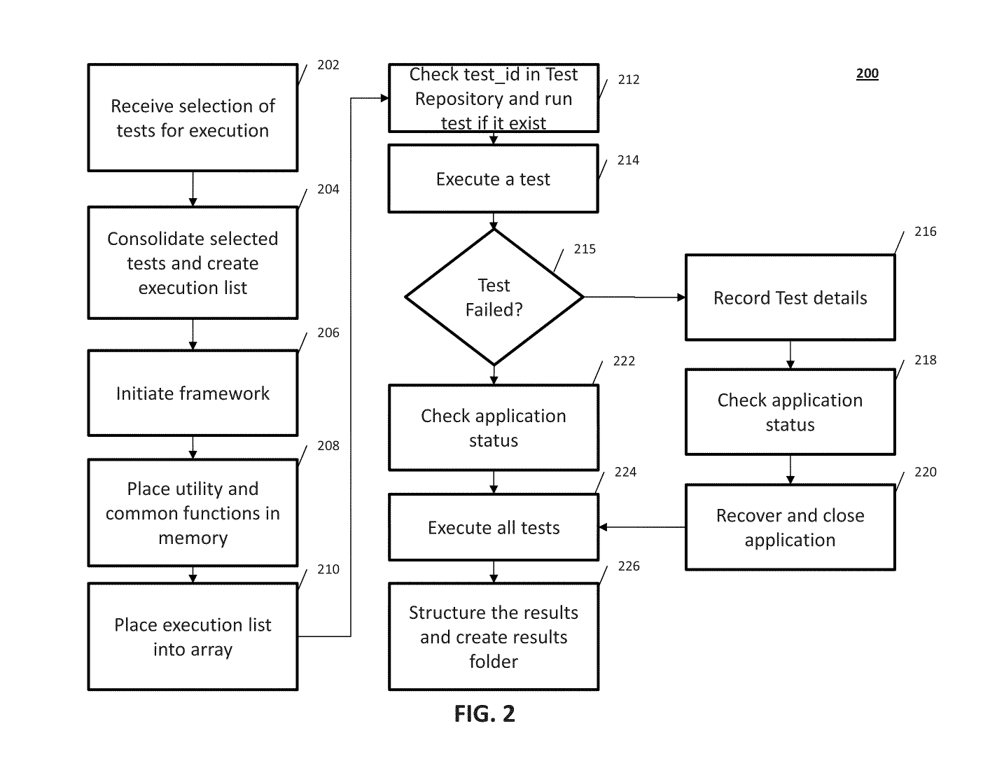

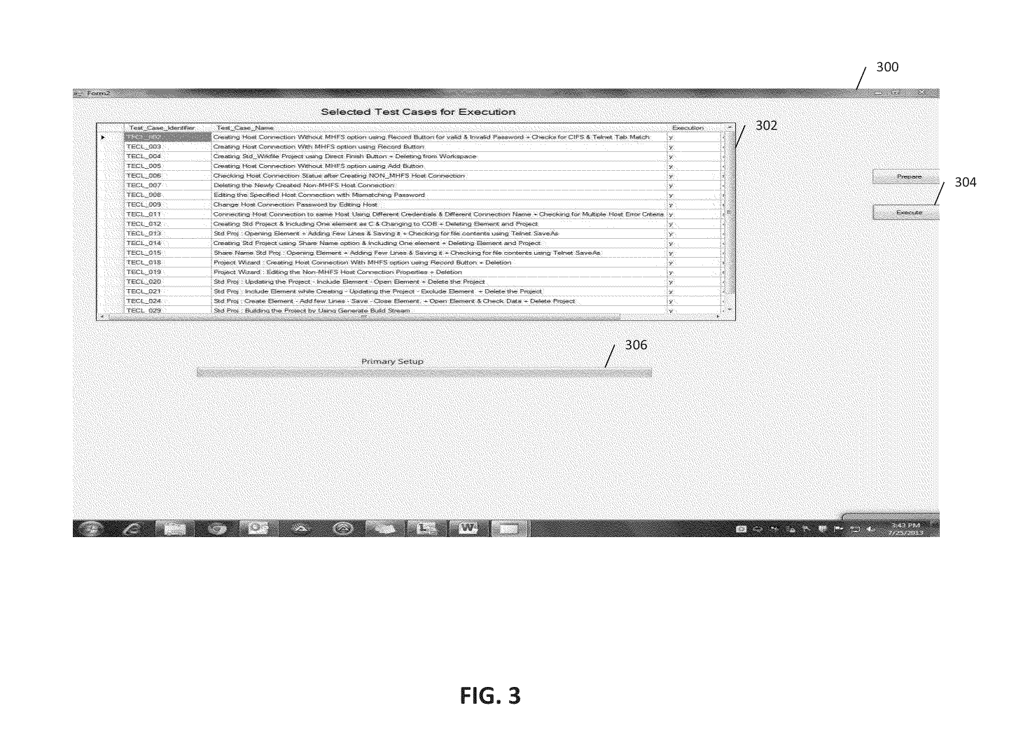

Referring now to FIG. 2, a method 200 for the reusable test automation framework is illustrated. The method 200 begins at step 202 when the reusable test automation framework receives a selection of test scripts for execution from the user through the test script selector. The user may select test scripts for execution using a graphical user interface, such as the user interface 300 illustrated in FIG. 3. The user interface 300 includes a list of test scripts available for selection in a test scripts list window 302. Once the user selects all the necessary scripts, the user may select an execute button 304 to begin the testing process. The user interface 300 may display the progress of the testing process to the user using a progress bar 306.

In FIG. 2, the method 200 continues in step 204 when the reusable test automation framework consolidates the selected test scripts and creates an execution list using the selected test scripts. Step 204 may begin when the reusable test automation framework receives an execute command from the user, or the reusable test automation framework may begin the testing process automatically. The execution list created by the reusable test automation framework may prioritize some tests and order the test scripts accordingly. In another embodiment, the execution list may resemble an order selected by the user. The reusable test automation framework uses the execution list to reference a test script from the test script repository and perform the test according to the instructions included in the test script.

After creating the execution list in step 204, the driver script initiates the reusable test automation framework in step 206 and places the called utility and common functions of the library functions into memory in step 208. The test scripts may reference the utility and common functions in memory any time the script calls for such a function or variable stored in the library functions.

Subsequently, in step 210, the driver script reads the execution list and puts the test scripts of the execution list into an array. The array may contain all the test script names and also the multiple sets of data from the test data storage for each test script, if applicable. The array may contain any necessary data or metadata used to perform all the test scripts. In step 212, the driver script begins executing the test scripts by looking at the test names (test id) in the array and searching the test repository for a test script that matches the test name (test id) in the execution list or array.

Subsequently, the first test in the execution list is executed in step 214. After the test executes, the driver script determines if the test failed or passed in step 215. If the test failed, the driver script records the test details in step 216. For example, the details may include a log describing the steps of the test with a failure snapshot of the AUT. The driver script may subsequently place the results into a temporary folder, and the driver script, using the results consolidation module (results module) translates and formats the results in the temporary folder may for display to the user after all tests have executed. After recording the details of the failure, the driver script calls the application status checker (app_status_checker) to check the status of the AUT in step 218. If the test failed, the application status checker (app_status_checker) recovers and closes the AUT in step 220 before moving on to the next test script.

If the test passed in step 215, the driver script calls the application status checker (app_status_checker) to check the status of the application in step 222. If the application is running normally, no additional steps need to be taken by the application status checker (app_status_checker). In some embodiments, the driver script may also create log data and snapshot data for passed tests as well as failed tests.

The driver script repeats steps 212-222 until all test scripts have been executed by the driver script in step 224. During testing, the driver script uses descriptive scripting so that all application changes are handled, and object descriptions are embedded into the test script itself. In this way, the reusable test automation framework does not have the overhead of maintaining an object repository file.

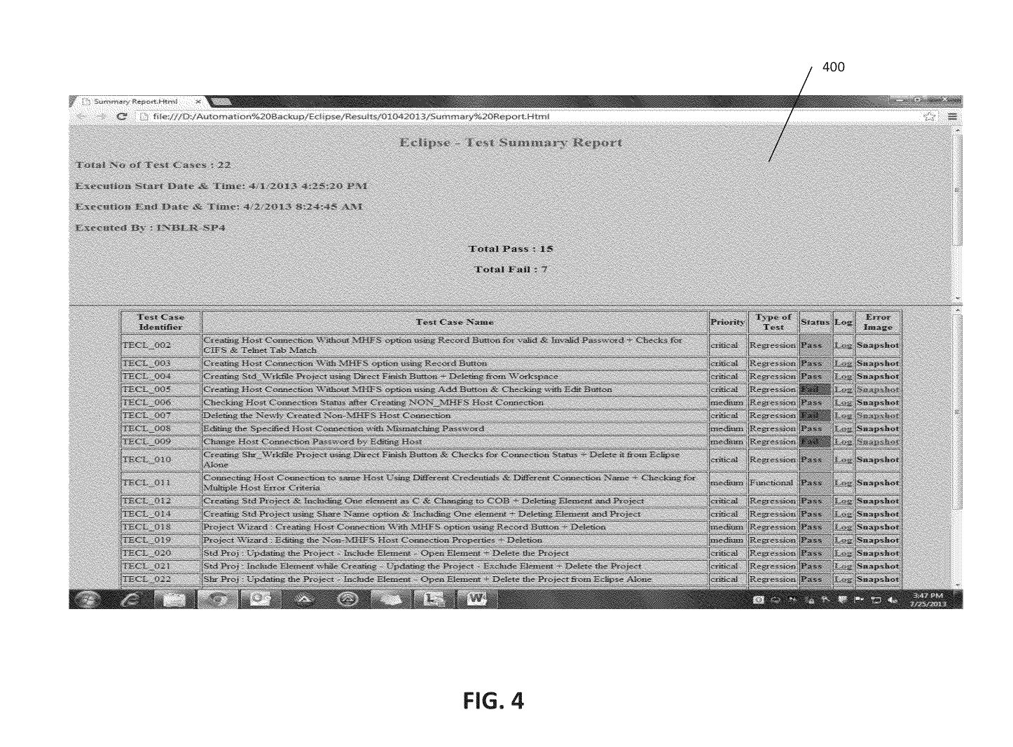

After all the test scripts have been executed, the driver script calls the result consolidation module (results module) to structure and format the results of all the tests in step 226. FIG. 4 illustrates an exemplary results page 400 displayed to a user. In the results page 400, the test name, the status of the test, the type of test, a log of the test, and a snapshot of the test is shown to the user. More information about the tests may also be included in the results page 400. Using this data, a software engineer may correct errors in the software based on the test. The test results may also include a date and time when the tests were performed.

According to the exemplary embodiments described above, an application independent testing framework performs testing on a plurality of different applications without substantial changes to the testing framework. Using the common and utility functions stored in memory, the test scripts can adapt to different applications, platforms, and other application configurations so that testing can be performed on a variety of different applications. In addition, the testing framework can synchronously perform many tests, even after test failures. If the application fails, the application initializer module restores, closes, and restarts the test before continuing testing of the AUT. Thus, the reusable test automation framework can handle errors dynamically. Further, the reusable test automation framework may be data driven, and each test can be executed using multiple sets of data. Such data-driven testing leads to more rigorous testing without additional work in creating a new framework for testing. Finally, the results of the test are easy to understand, and the results assist in fixing application errors.

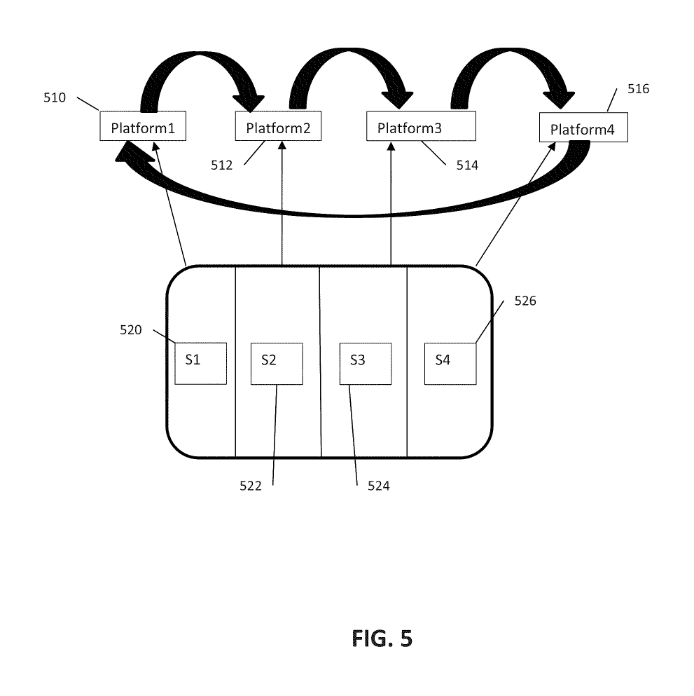

FIG. 5 illustrates a cyclical method of testing an application. Using the cyclical method, a set of tests is performed on multiple platforms in subsets. As a result, only a portion of all the tests are performed on each platform, thus reducing testing time.

The exemplary embodiments of the cyclical method are best shown through a number-specific example. In the example shown in FIG. 5, a set of tests are to be performed on four platforms. In this example, it is assumed that 1000 tests are to be performed on the four platforms 510, 512, 514, 516. Each platform 510, 512, 514, 516 may implement a different operating system. For example, the first platform 510 may implement Windows XP, the second platform 512 may implement Windows 2003, the third platform 514 may implement Windows 2008 R2, and the fourth platform 516 may implement Windows 7. Rather than perform all 1000 tests on each platform 510, 512, 514, 516, the exemplary embodiments shown in FIG. 5 divide the total number of tests into four subsets 520, 522, 524, 526, and the number of subsets matches the number of platforms 510, 512, 514, 516. In this example, it is assumed that all tests execute in the same amount of time, and thus, the 1000 tests may be divided equally. So, the first subset 520, the second subset 522, the third subset 524, and the fourth subset 526 each have 250 tests. Each of the subsets 520, 522, 524, 526 is different, and all 1000 tests are distributed into one of the subsets 520, 522, 524, 526. In some situations, the subsets 520, 522, 524, 526 do not have the same amount of tests in each subset. The tests may be allocated into subsets 520, 522, 524, 526 according to any method, but preferably, all the platforms 510, 512, 514, 516 finish all the tests in their respectively allocated subsets 520, 522, 524, 526 in the same amount of time,

After each test has been allocated into one of the subsets 520, 522, 524, 526, the four platforms 510, 512, 514, 516 execute their respectively allocated subsets simultaneously. For example, the first platform 510 executes the first subset 520, the second platform 512 executes the second subset 522, the third platform 514 executes the third subset 524, and the fourth platform 516 executes the fourth subset 526. In other words, each platform 510, 512, 514, 516 performs one quarter of the total amount of tests. So, 1000 tests are performed in a quarter of the time it would take to run 1000 tests on each platform.

During the course of running all 1000 tests in parallel on the four platforms 510, 512, 514, 516, some errors may be discovered when tests fail. The results of the tests may be given to a software development team, and the software development team may generate a new application build addressing the errors. After the errors have been addressed or fixed, the new application build is ready for another round of testing.

During the second round of testing, each platform 510, 512, 514, 516 executes a different subset 520, 522, 524, 526 than the first round of testing. For example, each subset may be rotated such that the first platform 510 executes the fourth subset 526 during the second round, the second platform 512 executes the first subset 520 during the second round, the third platform 514 executes the second subset 522 during the second round, and the fourth platform 516 executes the third subset 524 during the second round,

If errors are again discovered, the software development team receives the results and failed tests, the software development team addresses the problems, and another round of testing occurs where the subsets are again rotated. According to this exemplary method, any given platform 510, 512, 514, 516 does not perform the same subset of tests during two consecutive testing rounds. For example, in the third round of testing, the first platform 510 executes the third subset 524 during the third round, the second platform 512 executes the fourth subset 526 during the third round, the third platform 514 executes the first subset 520 during the third round, and the fourth platform 516 executes the second subset 522 during the third round. This process repeats until no errors are found.

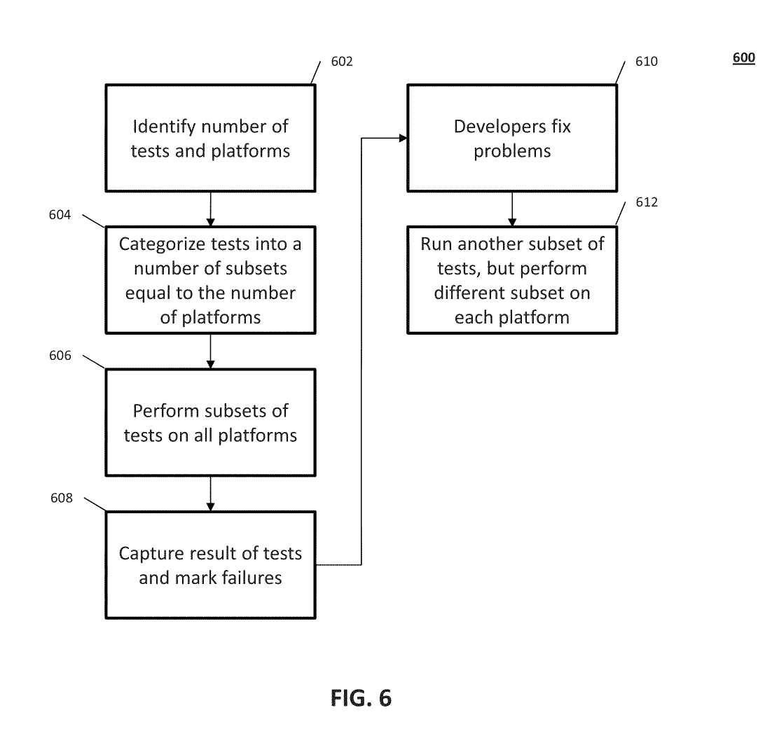

Referring now to FIG. 6, a cyclical testing method 600 is illustrated. The method 600 begins in step 602 when a computer identifies the number of tests included in the testing process and the number of platforms on which to perform the tests. A computer may select the tests based on the scope of a release of the AUT. For example, if the AUT has thirty features, a computer may select 300 tests rigorously testing every aspect of each feature several different ways. Alternatively, a computer may receive a selection of tests from a user. The number of platforms identified depends on the operating systems or computer configurations on which the AUT will typically be installed.

After the number of tests and the platforms have been identified, the tests are categorized into subsets in step 604. The number of subsets is equal to the number of platforms. Each subset does not necessarily have the same number of tests, but the number of tests allocated to each subset may depend on the time required to perform all tests in the subset. Preferably, the time required to execute all the tests in one subset should be similar in duration as the time required to execute all the tests in another subset. For example, all tests may require the same amount of time, and as a result, all subsets have an equal number of tests (Total number of tests/number of platforms). In another example, one subset of tests having 100 tests may require the same amount of time to execute all 100 tests as a subset having 250 tests. In this case, the computer allocates 100 tests to a first subset and 250 tests to a second subset. While similar testing duration is preferable, it is not required.

In addition to attempting to achieve similar duration times to execute all tests in all subset, tests may be categorized into subsets based on other factors. These other factors include test priority, historical data about previous bugs or issues, complexity of fixes involved for any given release, an AUTs release scope, modules or sub-modules related to tests, who designed the tests, test environment set up, test type, or any other factor about the tests or AUT.

After every test has been allocated into one of the subsets, each platform performs the tests in the subset assigned to each platform in step 606. Preferably, the platforms perform testing simultaneously so that the testing process for each platform ends at approximately the same time across all platforms. A computer may make note of which test set has been performed by which platform before, during, or after the platforms perform the allocated test subsets,

A server connected to the platforms, or the platforms themselves, may capture the results of the tests in step 608. Capturing the results of the tests may include marking failed tests. A computer may also capture logs or snapshots of the tests performed by each platform.

Using the results, a software development team determines and fixes bugs and other software errors in step 610. After fixing the problems, the software development team generates and builds a new software release, which is ready for another round of testing.

In step 612, each platform is allocated a new subset of tests. For example, in a first round of testing, a first platform tests a first subset, and a second platform tests a second subset, and in a second round of testing, the first platform tests the second subset, and the second platform tests the first subset.

Steps 606-612 are repeated until all the tests pass or until a deadline arrives. Alternatively, the number of testing cycles can depend on the complexity and size of the AUT the AUT has low in complexity, 75% of the tests should be executed on each platform, while failed and fixed tests should run twice on each platform. For example, if there are four platforms, three cycles will suffice, with an additional cycle of failed tests. If the AUT has medium complexity, 100% of the tests should be executed on each platform. For example, if there are four platforms, four cycles will suffice, with an additional cycle of failed tests if the AUT has high complexity, 100% of the tests should be executed twice on each platform. For example, if there are four platforms, eight cycles will suffice.

In the exemplary embodiment shown in FIG. 6, the number of testing systems is equal to the number of platforms. But this may not be the case in every instance. For example, an organization may have more testing systems than platforms on which to test the AUT, or the organization may have fewer testing systems than platforms on which to test the AUT.

In the case where there are more testing systems than platforms, the number of subsets should still match the number of platforms. For example, if an organization has five testing systems, and an AUT is to be tested on four platforms, four subsets are created. Four testing systems may still execute the four subsets simultaneously, but the fifth testing system can share the burden of any other testing system. The allocation of tests into subsets may different this strategy because multiple testing systems can execute one subset of tests. So, for example if 500 tests are to be performed on four platforms, three subsets may have 100 tests, and the fourth subset may have 200 tests, and two testing systems may perform the 200 tests in the fourth subset,

In the case where there are fewer testing systems than platforms, the number of subsets should still match the number of platforms. However, the testing systems may need to change platforms at one or more points during a testing cycle. Changing platforms may involve initializing a separate partition, initializing a virtual machine, or installing a new operating system on the testing system. For example, if an organization has two testing systems and four platforms, the two testing systems respectively install and open a first and a second platform. The first and the second subsets are performed on the first and second testing systems. After the first and second subsets complete the testing process, the testing systems both change platforms, and the third and fourth subsets are implemented.

The cyclical testing method greatly reduces the time required to test an AUT while still finding 98-99.5% of the errors in the AUT. in addition, this method keeps both the software testing and software development team busy at all times, while leveraging all available testing and development resources. As a result, bugs can be found and fixed while reducing the time required to test and debug AUTs.

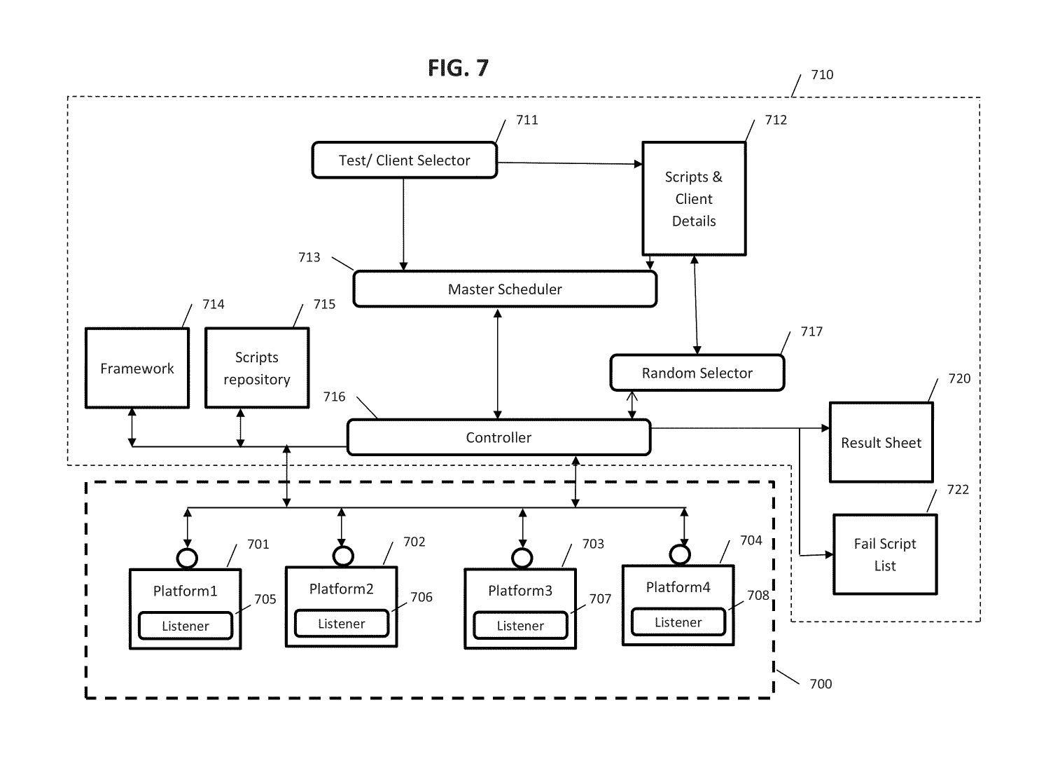

Referring to FIG. 7, the modules and computer systems involved in a random test selection method are illustrated. A group of client platforms 700 are connected to a server 710. The server 710 includes test framework and software modules for performing tests on applications each running on client computers 701, 702, 703, 704 in the group of client platforms 700. Each of the client computers 701, 702, 703, 704 may have installed a different platform or operating system. For example, the first client computer 701 may implement Windows 7, the second client computer 702 may implement Windows XP, the third client computer 703 may implement Windows 2008 R2, and the fourth client computer 704 may implement Windows 2003. Each client computer 701, 702, 703, or 704 implements a separate platform so that an application under test (ALIT) may be tested within multiple operating systems or platforms.

Each of the client computers 701, 702, 703, 704 must have installed a client listener application 705, 706, 707, 708. The client listener applications 705, 706, 707, 708 may be preinstalled on each platform 701, 702, 703, 704. The client listener application 705, 706, 707, 708 assists in reporting the results of tests to the server 710.

Each client computer 701, 702, 703, 704 includes hardware typical in a general purpose computer system. For example, each client computer 71)1, 702, 703, 704 at least includes a processor, memory, physical storage, and a network interface. Each client computer 701, 702, 703, 704 may communicate with the server 710 through a network interface. The server 710 may have similar hardware, but the hardware included in the server 710 may have different specifications and configurations. For example, the server 710 may have higher performance hardware for communicating with multiple computers and managing requests from multiple computers.

The server 710 includes a test and client selector 711, a scripts and client details module 712, a master scheduler 713, a framework 714, a scripts repository 715, a controller 716, and a random selector 717. Each of these modules assists in performing tests on the client computers 701, 702, 703, 704.

The test and client selector 711 is a software module that allows a user to select test to run from a list of available tests. The test and client selector 711 also allows the user to select which tests will be performed on which client computers 701, 702, 703, 704. For example, a user may select a first test to be performed on all the client computers 701, 702, 703, 704, and the user may also select a second test to only be performed on the first client computer 701. All these inputs may be received from the user through the test and client selector 711. For example, a graphical user interface may embody the test and client selector 711. Using the graphical user interface, the test and client selector 711 may display to the user available tests and available clients 701, 702, 703, 704. The graphical user interface embodying the test and client selector 711 may also display information about the clients 701, 702, 703, 704, such status information or which operating system each client computer 701, 702, 703, 704 is executing. The tests and client selector 711 may have two tabs in the graphical user interface. The first tab may list available tests, and the second tab may list available client computers 701, 702, 703, 704 connected to the server 710 through a network. A user may also begin the testing process by interacting with an execute button displayed by the test and client selector's 711 graphical user interface.

The test and client selector 711 displays tests and information about the client computer 701, 702, 703, 704 after receiving data from the scripts and client details module 712. The scripts and client details module 712 stores the names of all the available tests and information about the connected client computers 701. 702, 703, 704. The information about the client computers 701, 702, 703, 704 may include the platform installed on each client computer 701, 702, 703, 704, the status of each client computer 701, 702, 703, 704, and applications running on each client computer 701, 702, 703, 704. The test and client selector 711 also sends the scripts and client details module 712 data representing clients and tests selected by the user, In this way, the scripts and client details module 712 prevents the random selector 717 from randomly picking tests that were not selected by the user.

The master scheduler 713 receives the selected tests and clients from the tests and client selector 711, and the master schedule 713 interprets the entire execution of scripts. The master scheduler 713 instructs the controller 716 when to ask for a test from the random selector 717 and when to send a randomly selected test to one of the client computer 701, 702, 703, 704.

The framework 714 is a pre-developed framework of any kind for a test automation framework. The framework may be kept in a compressed format, such as a .zip format. The framework may be uncompressed at the direction of the controller 716. For example, the framework may be the reusable test automation framework described with reference to FIGS. 1 and 2,

The test repository 715 is a folder that contains all the independent, working test scripts. The test repository 715 includes all the test instructions, variables, and other aspects of each test script. In other words, the test repository 715 contains more substantive data than the test and client selector 711 or the scripts and client details module 712, both of which only contain test names.

The controller 716 controls the execution of the test scripts across all the client computers 701, 702, 703, 704. The controller 716 communicates with each client computer 701. 702, 703, 704 and sends the instructions of each selected test script to the client computers 701, 702, 703, 704. According to the procedures of the exemplary embodiments, the controller 706 may allocate tests to the client computers 701, 702, 703, 704 such that each client computer 701, 702, 703, 704 performs a different test. Alternatively, the controller 716 may provide the same test script from the test repository 715 to each client computer 701, 702, 703, 704 at the same time. Whenever a client computer 701, 702, 703, 704 completes a test, the controller 716 provides the client computer 701, 702, 703, 704 a new test to perform, if all tests have not been completed. When a new test is required for a client computer 701, 702, 703, 704, the controller 716 requests the random selector 717 to randomly pick a new test that has not yet been performed. The controller 716 distributes one test to each client computer 701, 702, 703, 704 at a time.

The controller 716 also receives data from the client listener modules 705, 706, 707, 708 installed on each client computer 701, 702, 703, 704. The client listener modules 705, 706, 707, 708 record information about a result of the test performed on the respective client computers 701, 702, 703, 704, such as failures, snapshots, logs, time taken to complete the test, or any other pertinent information, and the client listener modules 705, 706, 707, 708 send the results of the tests to the controller 716.

After receiving the results of each test from the client listener modules 705, 71)6, 707, 708, the controller 716 may verify the results of the test and update a results sheet 720 and a fail script list 722, if the results suggest one of the tests failed.

The random selector 717 receives the list of selected tests from the scripts and client details module 712 and picks one test in response to a request for a new test from the controller 716. For example, at the beginning of a testing process, the controller 716 may ask the random selector 717 for four randomly selected test for each client computer 701, 702, 703, 704. As the client computers 701, 702, 703, 704 complete the tests assigned, the controller 716 requests more randomly selected tests from the random selector 717 whenever one of the client computers 701, 702, 703, 704 is ready for another test.

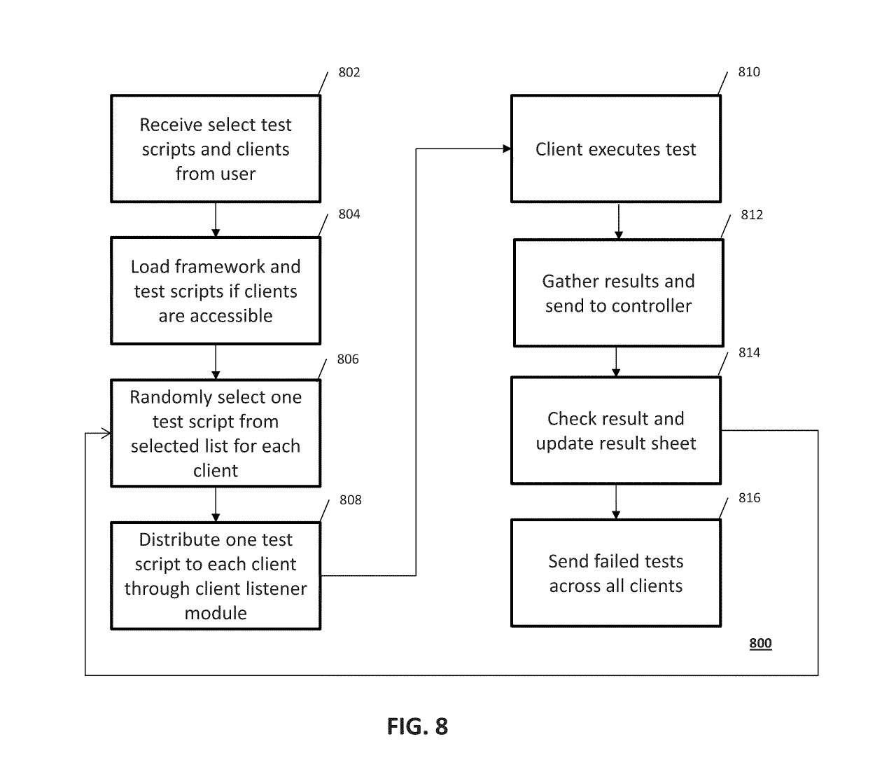

Referring now to FIG. 8, a random test selection testing method 800 is illustrated. The method 800 begins in step 802 when the server receives a selection of tests and clients from a user. The user may input these selections through a test and client selector module within a graphical user interface. The user may remotely connect to the server through a web-based interface and select the tests and clients using the web-based interface. The user selects tests to perform and also the types of platforms or operating systems on which to perform the selected tests. For example, a user may want to run fifty tests on four different platforms: Windows 7, Windows XP, Windows 2008 R2, and Windows 2003. While these four Windows-based platforms have been described for illustration purposes, any operating system or platform may be selected in the clients selection tab depending on which client computers are connected to the server. The test process may begin when a user selects an execute button within the graphical user interface.

When the tests are selected, and the user begins the testing process, the test and client selector notifies the master scheduler of the selected tests and clients. The master scheduler may first check the availability of client computers before beginning any testing on the client computers. Subsequently, the controller loads the framework and the test scripts from the test script repository into pre-defined paths in step 804.

After loading the framework and the selected test scripts, the controller requests the random selector to select one test script for each client in step 806. The number of tests selected at the beginning of the testing process may be the same as the number of clients. In the example of FIG. 7, four tests are selected, and each client computer gets one of the four randomly selected tests.

After a designated number of tests have been selected by the random selector, the controller distributes one test script to each client computer through the client listener modules in step 808. Each client listener module in the client computers reads or receives instructions from a test script saved in the test script repository. Following the instructions of the test script, the client computer runs the test script in step 810. After the test completes, the client listener gathers the generated test information and sends the test information, including logs, snapshots, etc., to the controller in step 812. Upon receiving the results from the client listeners, the controller verifies the results and updates the results sheet. If any tests failed, the controller also updates the failure script list.

The server and the client computers repeat steps 806-814 until all the selected scripts have been completed.

Once all the test scripts have been performed, the controller references the failed script list and sends the failed scripts across all the client computers in step 816. This step allows the controller to verify that the failure exists across all platforms, operating systems, and client computers.

By using the random selection method, testing time decreases because multiple tests may be run simultaneously on different platforms. Also, bugs, glitches, and other errors in the application under test may be quickly determined. Also, and most importantly, loading time for test scripts is reduced because only one test script is being loaded at a time, rather than an entire execution list containing all test scripts.

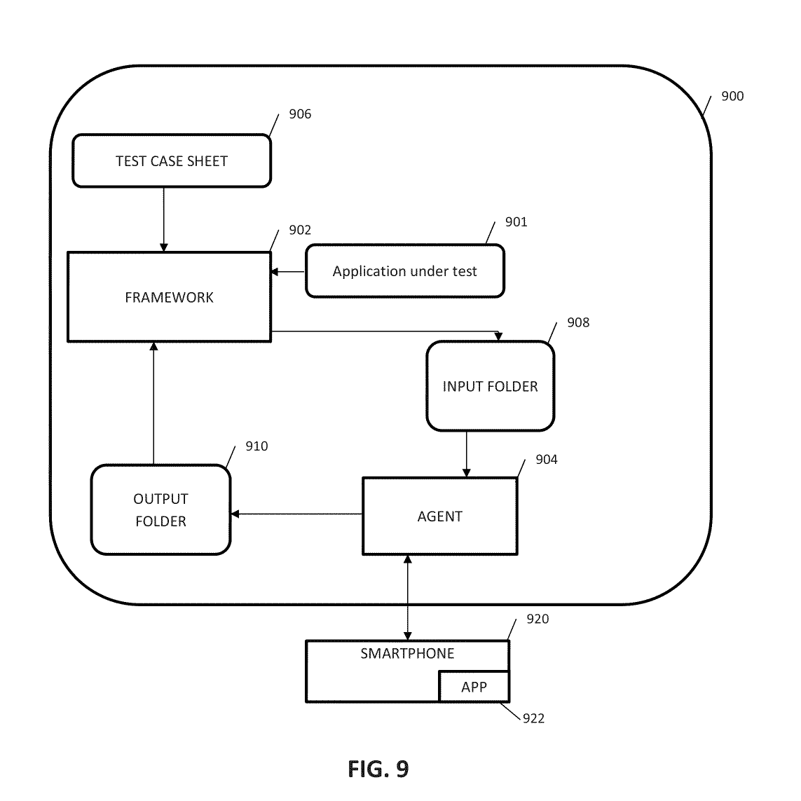

As many software engineers are on-the-go and cannot sit next to a testing computer running a test at all times, the exemplary embodiments also provide a smartphone application for managing testing software remotely. FIG. 9 illustrates exemplary components used to manage testing software with a smartphone application (“app”). Although referred to herein as a smartphone, it is intended that the smartphone can be a cellular phone, mobile phone, personal data assistant, tablet computer, or other mobile device. A computer running a test 900 communicates with a smartphone 920 executing a smartphone app 922. The server 900 includes an application under test (AUT) 901, a framework 902, an agent module 904, a test case sheet 906, an input folder 908, and an output folder 910.

The framework 902 is configured to fetch and execute test scripts in order to test the features, functions, and operations of the AUT 901. The framework 902 may store or connect to a test script repository where all test scripts are stored. The framework 902 is configured to place messages in the input folder 908 whenever an error occurs during testing. The framework 902 is also configured to monitor and read messages placed in the output folder 910 whenever a message is placed in the output folder 910 by the agent 904, and the framework 902 responds to the messages placed in the output folder 910. In this way, the input folder 908 and the output folder 910 are storage areas where messages can be placed so that a user using the smartphone 920 can see errors in the testing process and command the server 900 remotely.

The messages stored in the input folder 908 and the output folder 910 may have one of a plurality of standard message templates. The message template allows the user to send commands to the framework 902 through the smartphone 920. The message template is understood by the framework 902, the agent 904, and the smartphone app 922. The message template may be the same or different for each activity. Activities the smartphone app 922 could request the framework 902 to perform may include starting or stopping the AUT 901, error handling, clicking a button or a window within the AUT 901, etc. Any activity involved in the testing process may be performed using the message template.

The agent 904 acts as a mediator between the framework 902 and the smartphone app 922. The agent 904 sends messages to the smartphone app 922 using one of the message templates and receives messages from the smartphone app 922 using one of the message templates. The agent 904 monitors the input folder 908 for errors noted by the framework 902. Whenever the framework 902 reports an error by placing a message in the input folder 908, having one of the message templates, the agent 904 reports the error to the user by sending a message, having one of the message templates, to the smartphone 920. The message templates may include an information template that describes test execution status and results details, an error template that describes error details and available commands to respond to the error, and a warning template that describes any warnings generated by the framework (such as a resource that is not available to perform load testing). When the smartphone app 922 responds to the agent 904, the message templates may include a click template that commands the framework 902 to click a particular button within an error window that appeared on the server 900, a DOS template that commands the framework 902 to execute a particular DOS command, or a request template that requests the framework 902 for a status update about a particular test being executed.

In one embodiment, the message template sent to the smartphone 920 may be in the form of a text message or an email. The text message sent from the agent 904 may describe an error or a warning on the server 900. The text message also may describe understood text phrases that can be sent by the user to command the framework 902. For example, the error text message may say “Error white executing test name: ‘test1.’ Reply with ‘stop to stop tests. Reply with ‘continue’ to ignore test and begin the next test.” If the user responds with a text message that says “continue,” the agent 904 sends the command to the framework 902, and the framework 902 continues the testing process. In this example, the framework 902 does not continue the testing process until it receives a command sent from the user via the agent 904.

The smartphone app 922 acts as a translator between the agent 904 and the user. The user may interact with a user-friendly smartphone interface to respond to messages from the agent 904 or send messages to the agent 904. The smartphone app 922 may receive inputs from the user and translate the inputs into one of message templates so that the agent 904 may understand the requests by the user. The smartphone 922 further translates messages received from the agent 904 in the message template into a spoken language format. The smartphone 922 may report the message through text or sound. The smartphone app 922 may include options for the user whenever an error message is received from the agent 904. For example, the agent 904 may send a message to the smartphone app 922, and the smartphone app 922 may present two options to respond to the error message, such as “Ignore” and “Fix Error,” or the like.

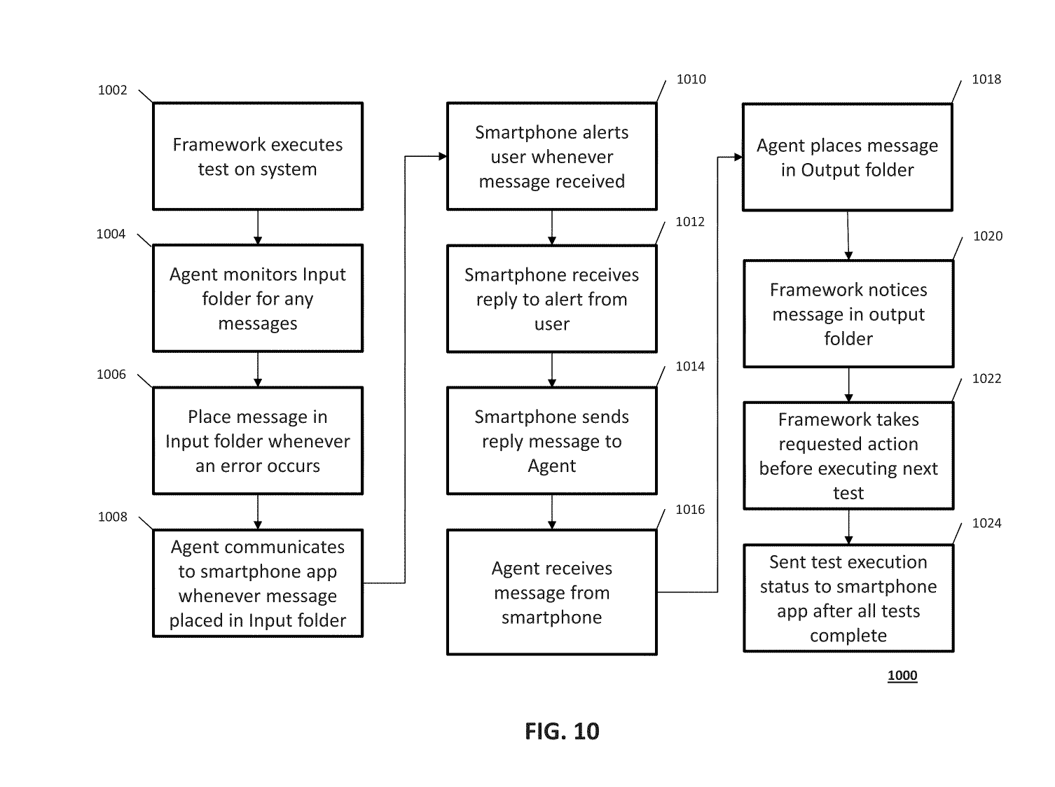

FIG. 10 illustrates a method 1000 of communication between the smartphone and the server during a testing process. In this exemplary method 1000, the framework will fetch and execute test scripts one-by-one on the server. The method 1000 begins in step 1002 when the framework executes a test on the server. Continuously while the server perform testing, the agent monitors the input folder for error messages (represented by step 1004). Whenever the framework encounters an unexpected error during testing, the framework places a message in the input folder in step 1006. The error message may include information about the error, such as the function or feature failing, the name of the test, or any other pertinent information.

When the agent notices that a message has been placed in the input folder, the agent communicates the message to the smartphone app in step 1008. Upon receiving the message from the agent, the smartphone alerts the user in step 1010. The smartphone app can present options to the user that are useful for responding to the error message. After reviewing the options, a user may select one of the responses, and the smartphone receives the selection from the user in step 1012. In response to the selection, the smartphone sends the selected response to the agent in step 1014. After a successful transmission, preferably over some wireless connection, such as WiFi, 4G, LIE, Bluetooth, or any other wireless network, the agent receives the selected response from the smartphone in step 1016. After receiving the selected response message from the smartphone app, the agent places the selected response message in the output folder in step 1018. The framework is configured to continually monitor the output folder for messages, and when the framework notices that a message has been placed in the input folder by the agent in step 1020, the framework takes the requested action before executing the next test in step 1022. For example, the framework may handle an unexpected error by restarting the application.

The server and the smartphone repeats steps 10024022 until all test have been performed. After each test has been performed, the agent may send the smartphone app a test execution status message. The test execution status message may include information about whether the test passed or failed, a tog of the test, or a snapshot. The amount of information displayed to the user may depend on settings of the smartphone app that may have been previously set by the user. After all tests finish, the agent may send another message to the smartphone alerting the user that the testing process has finished. The message may further include a summary of all the tests performed, including information such as whether each test passed or failed.

The smartphone application provides a convenient platform to track test execution status. The smartphone application also allows a software engineer monitoring the testing process to monitor the status while away from the computer system performing the testing process. Software engineers also can respond immediately to errors without routinely checking the status of the test at the server's location.

The exemplary embodiments can include one or more computer programs that embody the functions described herein and illustrated in the appended flow charts. However, it should be apparent that there could be many different ways of implementing aspects of the exemplary embodiments in computer programming, and these aspects should not be construed as limited to one set of computer instructions. Further, those skilled in the art will appreciate that one or more acts described herein may be performed by hardware, software, or a combination thereof, as may be embodied in one or more computing systems.

The functionality described herein can be implemented by numerous modules or components that can perform one or multiple functions. Each module or component can be executed by a computer, such as a server, having a non-transitory computer-readable medium and processor. In one alternative, multiple computers may be necessary to implement the functionality of one module or component.

Unless specifically stated otherwise as apparent from the following discussion, it is appreciated that throughout the description, discussions utilizing terms such as “generating” or “determining” or “receiving” or “sending” or “negotiating” or the like, can refer to the action and processes of a data processing system, or similar electronic device, that manipulates and transforms data represented as physical (electronic) quantities within the system's registers and memories into other data similarly represented as physical quantities within the system's memories or registers or other such information storage, transmission or display devices.

The exemplary embodiments can relate to an apparatus for performing one or more of the functions described herein. This apparatus may be specially constructed for the required purposes, or it may comprise a general purpose computer selectively activated or reconfigured by a computer program stored in the computer. Such a computer program may be stored in a machine (e.g. computer) readable storage medium, such as, but is not limited to, any type of disk including floppy disks, optical disks, CD-ROMs and magnetic-optical disks, read only memories (ROMs), random access memories (RAMs) erasable programmable ROMs (EPROMs), electrically erasable programmable ROMs (EEPROMs), magnetic or optical cards, or any type of media suitable for storing electronic instructions, and each coupled to a bus.

The exemplary embodiments described herein are described as software executed on at least one server, though it is understood that embodiments can be configured in other ways and retain functionality. The embodiments can be implemented on known devices such as a personal computer, a special purpose computer, cellular telephone, personal digital assistant (“PDA”), a digital camera, a digital tablet, an electronic gaming system, a programmed microprocessor or microcontroller and peripheral integrated circuit element(s), and ASIC or other integrated circuit, a digital signal processor, a hard-wired electronic or logic circuit such as a discrete element circuit, a programmable logic device such as a PLD, PLA, FPGA, PAL, or the like. In general, any device capable of implementing the processes described herein can be used to implement the systems and techniques according to this invention.

It is to be appreciated that the various components of the technology can be located at distant portions of a distributed network and/or the Internet, or within a dedicated secure, unsecured and/or encrypted system. Thus, it should be appreciated that the components of the system can be combined into one or more devices or co-located on a particular node of a distributed network, such as a telecommunications network. As will be appreciated from the description, and for reasons of computational efficiency, the components of the system can be arranged at any location within a distributed network without affecting the operation of the system. Moreover, the components could be embedded in a dedicated machine

Furthermore, it should be appreciated that the various links connecting the elements can be wired or wireless links, or any combination thereof, or any other known or later developed element(s) that is capable of supplying and/or communicating data to and from the connected elements. The term module as used herein can refer to any known or later developed hardware, software, firmware, or combination thereof that is capable of performing the functionality associated with that element. The terms determine, calculate and compute, and variations thereof, as used herein are used interchangeably and include any type of methodology, process, mathematical operation or technique.

The embodiments described above are intended to be exemplary. One skilled in the art recognizes that numerous alternative components and embodiments that may be substituted for the particular examples described herein and still fall within the scope of the invention.

What is claimed is:

1. A method for reusing a test automation framework across multiple applications, the method comprising:
receiving, by a computer, a selection of one or more scripts from a user to test an application;
creating, by the computer, an execution list containing every selected test script;
copying, by the computer, at least one utility function and at least one common function into a computer-readable memory so that the at least one utility function and at least one common function are available to be referenced by an executed test script, wherein the utility function defines a function used by the test automation framework and the common function defines a function that is test script-specific;
referencing, by the computer, a test script repository for one of the one or more test scripts having a test name that matches a name in the execution list;
loading, by the computer, the instructions of the test script into the computer-readable memory when the test script is found in the test script repository;
executing, by the computer, the test script to test the application according to the instructions defined in the test script and according to computer instructions defined by the utility functions or the common functions when the test script calls either the common function or the utility function;
checking, by the computer, a status of the application after the test terminates operation; and
recovering and closing, by the computer, the application if the application failed before executing a second test script testing the application under test.

2. The method of claim 1, further comprising:
recording, by the computer, test details describing how the application under test reacts to the instructions of the test script during testing.

3. The method of claim 2, wherein the test details include a log describing application status during every step of the test script.

4. The method of claim 2, wherein the test details include a snapshot of the application after the test script terminates.

5. The method of claim 2, further comprising:
formatting, by the computer, the test details into an HTML format for display to the user.

6. The method of claim 1, further comprising:
determining, by the computer, whether the test script needs to be executed for multiple sets of input data; and
gathering, by the computer, the multiple sets of input data from a test data storage for the test script.

7. The method of claim 1, wherein the user selects the test scripts through a graphical user interface.

8. The method of claim 1, wherein the execution list has an order for the one or more test scripts based on a priority associated with each of the one or more test script.

9. The method of claim 1, wherein the common functions and the utility functions are written using the AutoIt scripting language.

10. The method of claim 1, wherein object descriptions are embedded into each of the one or more test scripts.

11. A computer program product, comprising a computer usable medium having a computer readable program code embodied therein, the computer readable program code adapted to be executed to implement a method for testing an application, the method comprising:
providing a first system, wherein the first system comprises distinct software modules, and wherein the distinct software modules comprises an application setup initializer module, an application status checker module, a test script selector module, and a driver module;
receiving, by the test scripts selector module, a selection of one or more test scripts from a user to test the application;
creating, by the driver module, an execution list containing every selected test script;
copying, by the driver module, utility functions and common functions into computer-readable memory so that the utility functions and common functions are available to be referenced by an executed test script, wherein the utility functions define functions used by a test automation framework and the common functions define functions that are test script-specific;
referencing, by the driver module, a test script repository for one of the one or more test scripts having a test name that matches a name in the execution list;
loading, by the driver module, the instructions of the test script into the computer-readable memory when the test script is found in the test script repository;
executing, by the driver module, the test script testing the application according to the instructions defined in the test script and according to computer instructions defined by the utility functions or the common functions when the test script calls either the common functions or the utility functions;
checking, by the application status checker module, the status of the application after the test terminates operation; and
recovering and closing, by the application initializer module, the application if the application tailed before executing a second test script testing the application.

12. The method of claim 11, further comprising:
recording, by the application status checker, test details describing how the application under test reacts to the instructions of the test script during testing.

13. The method of claim 12, wherein the test details include a log describing application status during every step of the test script.

14. The method of claim 12, wherein the test details include a snapshot of the application after the test script terminates.

15. The method of claim 12, wherein the distinct software modules further comprise a results consolidation module.

16. The method of claim 15, further comprising:
formatting, by the results consolidation module, the test details into an HTML format for display to the user.

17. The method of claim 11, wherein the distinct software modules further comprise a data driven module.

18. The method of claim 17, further comprising:
determining, the data driven module, whether the test script needs to be executed for multiple sets of input data; and
gathering, by the driver module, the multiple sets of input data from a test data storage for the test script.

19. The method of claim 11, wherein the execution list has an order for the one or more test script based on a priority associated with each of the one or more test script.

20. The method of claim 11, wherein the common functions and the utility functions are written using the AutoIt scripting language.

21. The method of claim 11, wherein object descriptions are embedded into each of the one or more test scripts.
